(19) United States
(12) Patent Application Publication
(10) Pub. No.: US 2007/0255557 A1
(43) Pub. Date: Nov. 1, 2007

(54) Morphology-based speech signal codec method and apparatus

(75) Inventor: Hyun-Soo Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Gyeonggi-do (KR)

(21) Appl. No.: 11/725,589

(22) Filed: Mar. 19, 2007

(30) Foreign Application Priority Data
Mar. 18, 2006 (KR) 2006-25104

(51) Int. Cl. G10L 19/12

(52) U.S. Cl. 704/205; 704/221; 704/222; 704/E19.001

(57) ABSTRACT

Disclosed is a function of applying a speech signal to a harmonic codec without distinguishing a voiced signal from an unvoiced signal. A peak portion having harmonic and non-harmonic components is extracted from a speech signal based on morphology, and a characteristic frequency is extracted from the extracted peak portion and applied to a harmonic codec. The harmonic codec is a general sinusoidal codec applied to all speech signals. Accordingly, a morphology-based pre-processing method for extracting a characteristic frequency can be easily applied to other speech signal characteristic extracting methods, and performance of other systems using the morphology-based pre-processing method is significantly increased due to a characteristic of a pre-processed signal.

### PRIORITY

This application claims priority under 35 U.S.C. § 119 to an application entitled “Morphology-Based Speech Signal Codec Method and Apparatus” filed in the Korean Intellectual Property Office on Mar. 18, 2006 and assigned Serial No. 2006-25104, the contents of which are incorporated herein by reference.

### BACKGROUND OF THE INVENTION

1. Field of the Invention

The present invention relates generally to a speech signal processing method and apparatus, and in particular, to a morphology-based speech signal codec method and apparatus to apply a speech signal to a harmonic codec without distinguishing a voiced sound from an unvoiced sound.

2. Description of the Related Art

A series of efforts have been performed to reduce a data rate needed to code a speech signal and obtain a high quality decoded speech signal in a receiver side of a system. Various codecs have been suggested as a result of these efforts, one of which is a Code Excited Linear Prediction (CELP) speech codec.

FIG. 1A is a diagram of a CELP speech codec method. If a speech signal 101 is input, the input speech signal is divided into a voiced signal 103 and an unvoiced signal 105 and respectively provided to a harmonic codec 107 and a non-harmonic codec 109 for separately coding the voiced signal and the unvoiced signal as illustrated in FIG. 1A.

A sinusoidal represented speech codec is based on the assumption that a pitch interval, i.e., a period of a voiced part, is constant for only a voiced sound having a periodic component since the periodic component contains most of the information and significantly affects sound quality. Since a sinusoidal represented speech codec performs only coding of a voiced sound under the assumption of a harmonic structure of a speech signal, it is difficult to represent an input speech signal without a loss. In particular, it is known that an unvoiced sound does not have periodicity, and a coding method is applied to the unvoiced sound using the attribute of a noise signal under the assumption that a structure of the unvoiced sound is similar to a structure of a noise signal.

However, a speech signal is generally divided into a periodic or harmonic component and a non-periodic or random component, i.e., a voiced sound and an unvoiced sound, according to statistical characteristics in a time domain and a frequency domain. A key point is how correctly a speech signal is divided into a voiced sound and an unvoiced sound and analyzed. In other words, a speech signal always includes a voiced sound and an unvoiced sound, and thus good performance can be obtained only if the speech signal is correctly analyzed and coded. However, according to a conventional CELP method, even though a voiced sound and an unvoiced sound are distinguished from each other and applied to respective codecs as illustrated in FIG. 1A, coding is performed by separate codecs, and according to a sinusoidal represented speech codec method, coding is performed only for a voiced sound by assuming a harmonic structure.

FIG. 1B illustrates a signal waveform of a speech signal having a harmonic structure. Furthermore, the sinusoidal represented speech codec method operates under an assumption that sine wave regions A and noise regions B appear periodically and each region appears repeatedly with a constant period as illustrated in FIG. 1B.

As described above, even though conventional codec methods mainly perform coding by distinguishing a voiced sound from an unvoiced sound, there hardly exists a method of correctly extracting and analyzing a voiced sound and an unvoiced sound and applying the extracted and analyzed voiced sound and unvoiced sound to separate codecs. Thus, extensive research is being conducted to solve this problem. In addition, a harmonic codec can only perform coding on a voiced sound.

### SUMMARY OF THE INVENTION

An aspect of the present invention is to substantially solve at least the above problems and/or disadvantages and to provide at least the advantages below. Accordingly, an aspect of the present invention is to provide a morphology-based speech signal codec method and apparatus to apply a speech signal to a harmonic codec without distinguishing a voiced sound from an unvoiced sound.

According to one aspect of the present invention, there is provided a morphology-based speech signal codec method that includes receiving a speech signal and converting the received speech signal in a time domain to a speech signal in a frequency domain; performing a morphological operation of the converted speech signal in a predetermined window unit; extracting a characteristic frequency from a result of the morphological operation; and applying the extracted characteristic frequency to a sinusoidal codec used for all speech signals.

According to another aspect of the present invention, there is provided a morphology-based speech signal codec apparatus that includes a frequency domain converter for receiving a speech signal and converting the received speech signal in a time domain to a speech signal in a frequency domain; a morphological filter for performing a morphological operation on the converted speech signal in a predetermined window unit; a characteristic frequency region extractor for extracting a characteristic frequency from a result of the morphological operation; and a sinusoidal codec for applying the extracted characteristic frequency to all speech signals.

### BRIEF DESCRIPTION OF THE DRAWINGS

The above and other objects, features and advantages of the present invention will become more apparent from the following detailed description when taken in conjunction with the accompanying drawing in which:

FIG 1A is a diagram of a CELP speech codec method;

FIG 1B is a waveform diagram of a speech signal having a harmonic structure;

FIG. 2A is a diagram of a sinusoidal codec method according to the present invention;

FIG. 2B is a waveform diagram of a speech signal to explain the concept illustrated in FIG. 2A in more detail;

FIG. 3 is a block diagram of a morphology-based speech signal codec apparatus according to the present invention;

FIG. 4 is a flowchart illustrating a morphology-based speech signal codec method according to the present invention;

FIG. 5 is a detailed flowchart illustrating a process of determining optimum SSS illustrated in FIG. 4; and

FIG. 6 illustrate waveform diagrams of a speech signal for which pre-processing is performed by morphological closing according to the present invention.

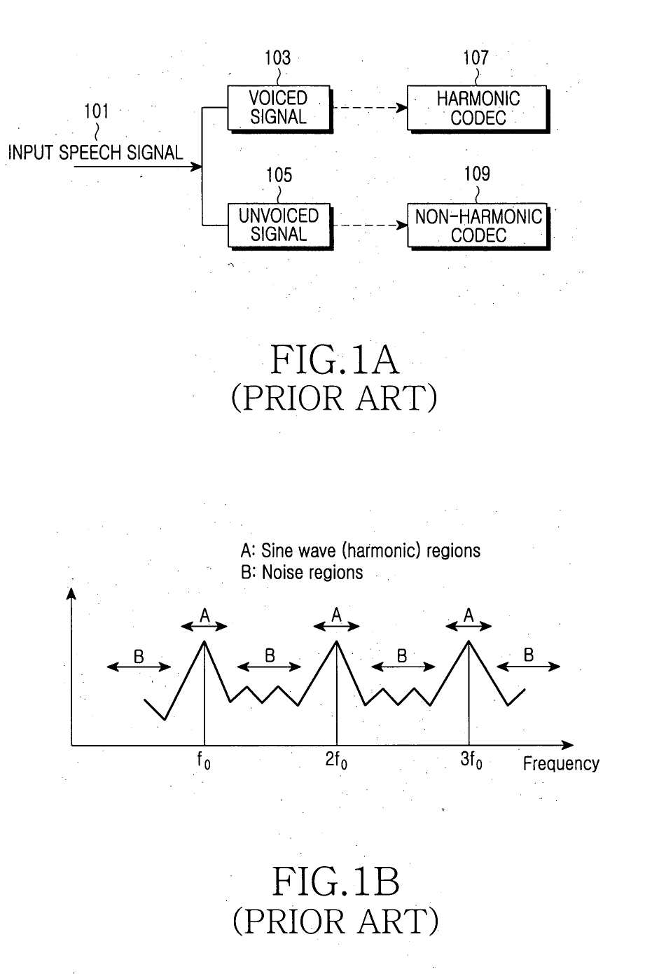

### DETAILED DESCRIPTION OF THE PREFERRED EMBODIMENT

Preferred embodiments of the present invention will be described herein below with reference to the accompanying drawings. In the following description, well-known functions or constructions are not described in detail since they would obscure the invention in unnecessary detail.

The present invention implements a function of applying a speech signal to a harmonic codec without distinguishing a voiced signal from an unvoiced signal. To do this, a peak portion having harmonic and non-harmonic components is extracted from a speech signal based on morphology, and a characteristic frequency is extracted from the extracted peak portion and applied to a harmonic codec. The harmonic codec is a general sinusoidal codec applied to all speech signals. Accordingly, a morphology-based pre-processing method for extracting a characteristic frequency can be easily applied to other speech signal characteristic extracting methods, and performance of other systems using the morphology-based pre-processing method is significantly increased due to a characteristic of a pre-processed signal.

Prior to description of the present invention, a morphological operation applied to the present invention will now be described.

Morphology is usually used for image signal processing, and morphology in a mathematical concept is a nonlinear image processing and analyzing method concentrating on a geometric structure of an image, in which erosion and dilation corresponding to a primary operation, and opening and closing corresponding to a secondary operation are important. A plurality of linear or nonlinear operators can be formed using a set of simple morphologies.

The most basic operation is erosion. In an erosion of a set A by a set B, A denotes an input image, and B denotes a structuring element. If an origin is in the structuring element, erosion tends to shrink the input image. A second basic operation, i.e., dilation, is a dual operation of erosion and is defined as a set complementation of erosion. One of second best operations, i.e., opening, is an iteration of erosion and dilation, and the other second best operation, i.e., closing, is a dual operation of opening.

In detail, a dilation operation determines maxima of each predetermined threshold set of a speech signal image as values of the threshold set. An erosion operation determines minima of each predetermined threshold set of a speech signal image as values of the threshold set. An opening operation is an operation performing the dilation operation after the erosion operation and shows a smoothing effect. A closing operation is an operation performing the erosion operation after the dilation operation and shows a filling effect.

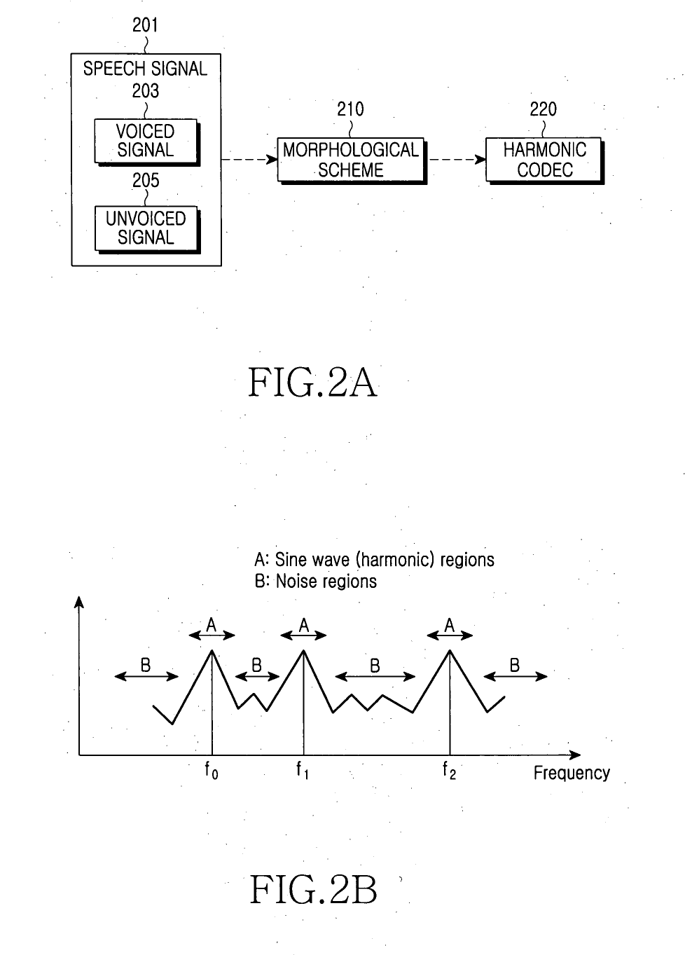

As described above, if the morphological operation is used when a characteristic frequency is extracted, a harmonic signal and a non-harmonic signal can be correctly divided and extracted. Thus, if a morphological scheme 210 is applied to the present invention as illustrated in FIG. 2A, valid characteristic frequency regions can be extracted from a speech signal 201 in which a voiced sound 203 and an unvoiced sound 205 are mixed, and applied to a harmonic codec 220. That is, if the morphological scheme is applied, the non-harmonic signal also can be applied to the harmonic codec. FIG. 2A is a diagram of a sinusoidal codec method according to the present invention. The concept illustrated in FIG. 2A will now be described in more detail with reference to FIG. 2B. FIG. 2B illustrates a general sinusoidal-plus-noise decomposition method applied to every speech signal regardless of harmonic or non-harmonic for a general sinusoidal case. In particular, FIG. 2B illustrates a case where each of since wave regions A and noise regions B has a variable length and is non-periodic. In FIG. 2B, frequencies ƒ₀,ƒ₁,ƒ₂, . . . corresponding to the peaks of the sine waves, i.e., major sine wave components, correspond to characteristic frequency regions, and even though intervals between the characteristic frequency regions are irregular, all speech signals can be represented using a set of sine waves by using the morphological scheme of the present invention. Thus, even though lengths of A and B regions are different as illustrated in FIG. 2B, every speech signal can be processed by the harmonic codec based on the invention morphology.

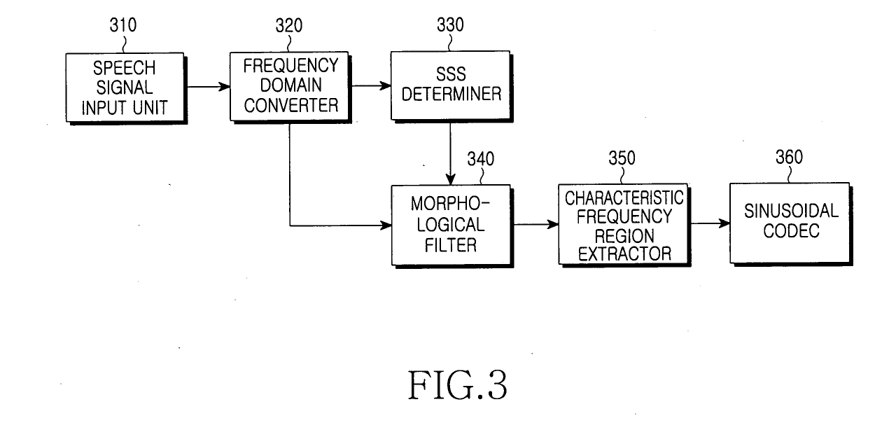

FIG. 3 is a block diagram of a morphology-based speech signal codec apparatus according to the present invention.

Referring to FIG. 3, the morphology-based speech signal codec apparatus includes a speech signal input unit 310, a frequency domain converter 320, a structuring set size (SSS) determiner 330, a morphological filter 340, a characteristic frequency region extractor 350, and a sinusoidal codec 360.

The speech signal input unit 310 can be comprised of a microphone and receives a speech signal including audio and acoustic signals. The frequency domain converter 320 converts the received speech signal from a time domain to a frequency domain.

The frequency domain converter 320 converts a speech signal in the time domain to a speech signal in the frequency domain using fast Fourier transform (FFT). Herein, to reduce a quantization effect, a zero padding process can be additionally applied. In this case, frequency estimation can be performed with increased accuracy without double pitch or half pitch.

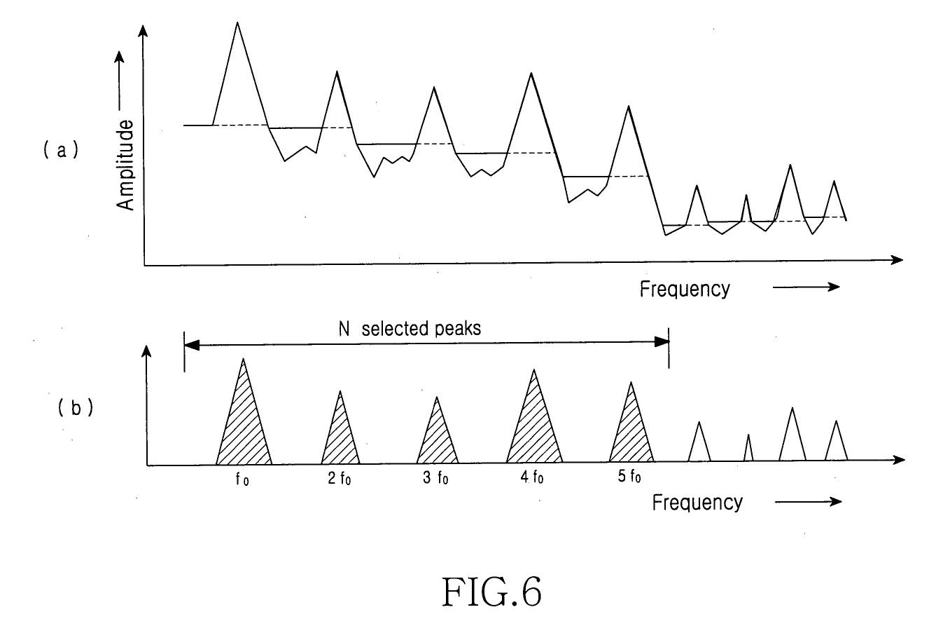

The morphological filter 340 selects harmonic peaks through the morphological closing. After performing the morphological closing, a waveform illustrated in diagram (a) of FIG. 6 is obtained. If the waveform illustrated in diagram (a) of FIG. 6 is pre-processed, a remainder (or residual) spectrum type waveform illustrated in diagram (b) of FIG. 6 is obtained. The remainder spectrum indicates signals existing above a closure floor represented by a dotted line illustrated in diagram (a) of FIG. 6, and after the pre-processing, only characteristic frequency regions remain as illustrated in diagram (b) of FIG. 6. After the pre-processing, signals obtained by removing staircase signals from signals output after performing the morphological closing are the signals illustrated in diagram (b) of FIG. 6. Through the pre-processing, harmonic content is emphasized in a voiced sound, and a major sinusoidal component is emphasized in an unvoiced sound.

In order to optimize the performance of the morphological filter 340, it is necessary to determine how large of a window unit is needed to perform a morphological operation. A morphological operation based on an optimum window unit must be performed. To determine the optimum window unit, the SSS determiner 330 is included. The SSS determiner 330 determines an SSS for optimizing the performance of the morphological filter 340 and provides the determined SSS to the morphological filter 340. A process of determining an SSS can be selectively used according to necessity, i.e., determined as a default or by a method described below.

The process of determining an SSS will now be described. If it is assumed that the number of signals having the greatest harmonic peak, i.e., the number of harmonic peaks, is N, that is, if N selected peaks corresponding to shadow areas of diagram (b) of FIG. 6 are defined, a value P is calculated using the N selected peaks. Herein, P denotes a ratio of energy of the N selected peaks to energy of the remainder spectrum. For example, in diagram (b) of FIG. 6, if N=5, a value obtained by summing the shaded areas is the energy E_{N} of the N selected peaks, and the energy of the remainder of the spectrum is Eₜₒₜₐₗ, P=E_{N}/Eₜₒₜₐₗ. The value P is compared to an SSS with no assumption regarding the signals, and if the value P is too large (e.g., SSS<0.5), N is decreased, and if the value P is too small (e.g., SSS>0.5), N is increased. Thus, since a speech signal has high pitches in a case of female speakers, the number of total harmonic peaks is small, and thus, a smaller N value is selected for female speakers as compared to male speakers. Through the above-described process, an optimum SSS of the morphological filter 340, which performs the morphological closing of a waveform converted to a speech signal in the frequency domain, is determined. If the method of selecting an SSS by adjusting N is not used, an optimum SSS may be selected by beginning from the smallest SSS and increasing the SSS on a step by step basis.

Since a morphological operation is a set-theoretical approach method depending on fitting a structuring element to a certain specific value, a one-dimensional image structuring element, such as a speech signal waveform, is represented as a set of discrete values. A structuring set is determined by a sliding window symmetrical to the origin, and the size of the sliding window determines performance of a morphological operation.

According to a preferred embodiment of the present invention, a window unit is obtained based on Equation (1)
window unit=(structuring set size (SSS)×2+1) (1)

As shown in Equation (1), a window unit depends on an SSS. The performance of a morphological operation can be adjusted by adjusting the size of a structuring set. The morphological filter 340 can perform a morphological operation, such as dilation, erosion, opening, or closing, using a sliding window according to an SSS determined by the SSS determiner 330.

The morphological filter 340 performs a morphological operation with respect to a waveform of the speech signal in the frequency domain using the SSS determined by the SSS determiner 330. The morphological filter 340 performs the morphological closing with respect to a waveform of the converted speech signal and performs the pre-processing.

A signal transforming method of the morphological filter 340 is a nonlinear method in which geometric features of an input signal are partially transformed. This has an effect of contraction, expansion, smoothing, or filling according to the four operations, i.e., erosion, dilation, opening, and closing. An advantage of this morphological filtering is that peak or valley information of a spectrum can be correctly extracted with a very small amount of computation. Furthermore, the morphological filtering is nonparametric. For example, unlike a conventional harmonic codec assuming a harmonic structure of a speech signal, no assumption exists for an input signal in the present invention.

The morphological closing provides an effect of filling valleys between harmonic peaks in a speech signal spectrum, and thus, as illustrated in diagram (a) of FIG. 6, the harmonic peaks remain while small spurious peaks exist below a morphological closing spectrum.

Thus, the characteristic frequency region extractor 350 can select only characteristic frequency regions included in the speech signal from a result of the morphological operation performed by the morphological filter 340. Only the characteristic frequency regions can be selected by suppressing noise. All characteristic frequency regions for representing the speech signal are extracted by selecting all of the harmonic peaks including small harmonic peaks as illustrated in diagram (b) of FIG. 6. If the extracted characteristic frequency regions have the attribute of a voiced sound, harmonic peaks having constant periodicity, such as ƒ₀, 2ƒ₀, 3ƒ₀, 4ƒ₀, 5ƒ₀, . . . , appear. That is, by applying the morphological scheme to the speech signal without distinguishing a voiced sound from an unvoiced sound, a characteristic frequency to be applied instead of a pitch frequency to a harmonic codec performing harmonic coding is extracted.

In particular, remainder peaks remaining by performing the pre-processing in diagram (b) of FIG. 6 appear due to a major sine wave component corresponding to the characteristic frequency of the speech signal. Unlike a general harmonic extracting method, the characteristic frequency is a frequency region of all sine waves representing a speech signal.

The sinusoidal codec 360 performs speech coding using the characteristic frequency extracted by the characteristic frequency region extractor 350. While harmonic coding shown in Equation (2) is applied to a harmonic codec, the sinusoidal codec 360 performs the harmonic coding using Equation (2) by replacing a pitch frequency with the characteristic frequency extracted through morphology according to the present invention.
|S(ω)|·e^{jθ(ω)}=(|P(ω)|·e^{jθ}^{_{P}}^{(ω)}+|N(ω)·e^{jθ}^{_{N}}^{(ω)})·|H(ω)|·e^{jθ}^{_{H}}^{(ω)} (2)

In Equation (2), while a conventional harmonic codec performs the harmonic coding by substituting a pitch frequency for ω, the harmonic coding is performed by substituting a sinusoidal component included in the speech signal, i.e., the extracted characteristic frequency, for ω in the present invention, and therefore the harmonic coding can be performed without distinguishing a voiced sound from an unvoiced sound. By substituting the characteristic frequency for ω instead of the pitch frequency in the harmonic codec of Equation (2), a general sine wave including harmonic and non-harmonic can be processed, and Equation (2) becomes a representation of a method applied to all speech signals. A harmonic codec using a characteristic frequency extracted using the morphological scheme becomes a general sinusoidal codec applied to all speech signals.

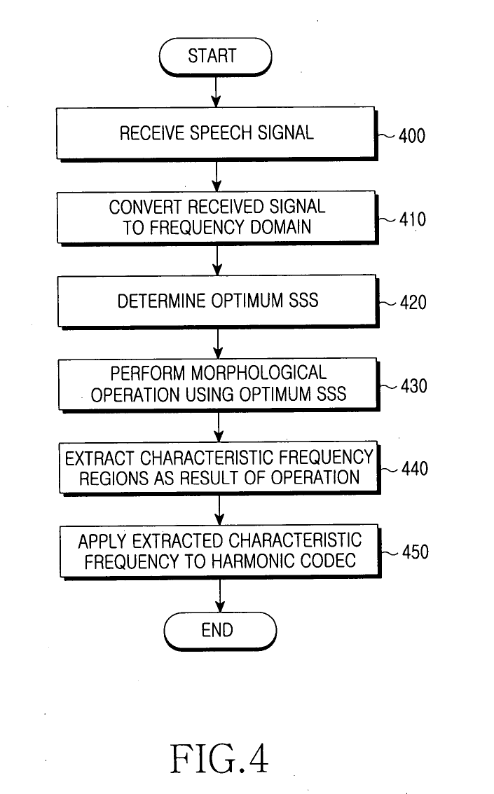

FIG. 4 is a flowchart illustrating a morphology-based speech signal codec method according to the present invention.

Referring to FIG. 4, the speech signal codec apparatus of FIG. 3 receives a speech signal through a microphone in step 400. The speech signal codec apparatus converts the received speech signal in the time domain to a speech signal in the frequency domain using FFT in step 410.

After converting the speech signal to the frequency domain, the speech signal codec apparatus determines an optimum SSS for optimizing the performance of a morphological operation in step 420. In step 430, the speech signal codec apparatus performs a morphological operation with respect to a waveform of the speech signal in the frequency domain using the determined optimum SSS and performs pre-processing. Herein, the morphological operation used in the current embodiment is the morphological closing, which is achieved through the iteration of dilation and erosion. In a case of an image signal, the morphological closing has a ‘roll ball’ effect for the surrounding of an image and tends to smooth comers while filtering the image from the outside.

If the pre-processing is performed after the morphological closing, the speech signal codec apparatus extracts a characteristic frequency as a result of the morphological operation in step 440. In detail, if a signal waveform illustrated in diagram (a) of FIG. 6 is obtained after the morphological closing of the speech signal, characteristic frequency regions having the signal waveform illustrated in diagram (b) of FIG. 6 are extracted by pre-processing the signal waveform illustrated in diagram (a) of FIG. 6. The characteristic frequency regions represent frequency regions of all sine waves representing a speech signal, and the characteristic frequency can be obtained from the characteristic frequency regions. In step 450, the speech signal codec apparatus applies the extracted characteristic frequency to a harmonic codec by substituting the characteristic frequency in Equation (2) for harmonic coding.

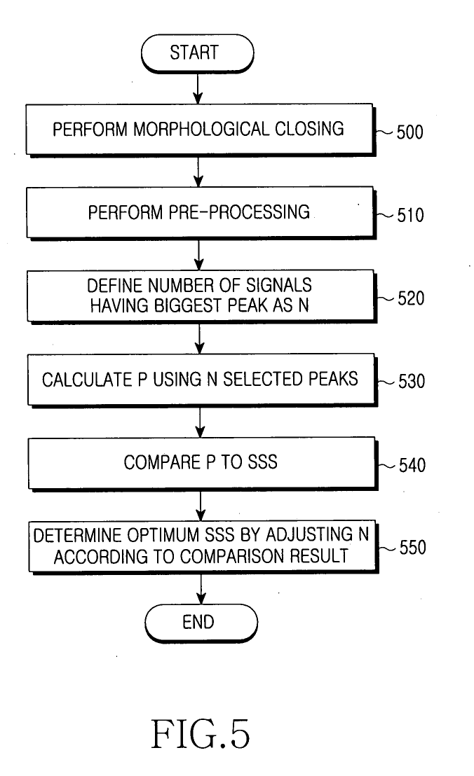

The optimum SSS can be determined by beginning from the smallest SSS and increasing the SSS on a step by step basis or by the algorithm described below. FIG. 5 is a detailed flowchart illustrating step 420 of FIG. 4.

Referring to FIG. 5, if a speech signal in the time domain is converted to a speech signal in the frequency domain, the speech signal codec apparatus performs the morphological closing in step 500 and outputs the waveform illustrated in diagram (a) of FIG. 6. In step 510, the speech signal codec apparatus performs pre-processing. As the pre-processing result, a result of a partial test morphological operation is input to the SSS determiner 330 to determine an optimum SSS.

In step 520, the speech signal codec apparatus defines the number of signals having the biggest harmonic peak as N. In step 530, the speech signal codec apparatus calculates a ratio P of energy of the N selected harmonic peaks to energy of a total remainder portion using the N selected harmonic peaks. In step 540, the speech signal codec apparatus compares the value P to a current SSS. In step 550, the speech signal codec apparatus determines an optimum SSS by adjusting N according to the comparison result. In other words, if the value P is greater than a predetermined value, N is decreased, and if the value P is less than the predetermined value, N is increased. As described above, by adjusting N, the optimum SSS can be determined. Herein, the SSS is a value to set a sliding window unit for the morphological operation, and performance of the morphological filter 340 depends on the sliding window unit.

As described above, by applying the morphological scheme according to the present invention to a speech signal, every speech signal can be represented as a set of sine waves based on a characteristic frequency without distinguishing a voiced sound from an unvoiced sound. In the present invention, a method of constituting a new sinusoidal codec is suggested by using the characteristic frequency in harmonic coding.

As described above, according to the present invention, a method of applying morphological scheme to a speech signal is suggested, and a very simple and correct speech characteristic information extracting method for extracting a characteristic frequency by extracting a harmonic portion and a non-harmonic portion using a closing operation is also suggested.

In addition, no assumption is necessary with respect to a signal or a system, and in particular, a pre-processing method can be easily applied to many speech signal characteristic extracting methods, and performance of other systems using the pre-processing method is significantly better due to a characteristic of pre-processed signals.

In addition, according to an application of morphology and a morphology-based characteristic frequency extracting method, speech processing can be correctly and quickly performed in speech coding, recognition, strengthening, or synthesis. In particular, a great effect can be expected by applying the present invention to devices, such as mobile communication terminals, telematics devices, personal digital assistances (PDAs), and MP3 devices, having high mobility, having limitation in computation or storage capacity, or requiring quick speech processing.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A morphology-based speech signal codec method comprising the steps of:
receiving a speech signal and converting the received speech signal in a time domain to a speech signal in a frequency domain;
performing a morphological operation on the converted speech signal in a predetermined window unit;
extracting a characteristic frequency from a result of the morphological operation; and
applying the extracted characteristic frequency to a sinusoidal codec used for all speech signals.

2. The method of claim 1, wherein the step of performing the morphological operation comprises the steps of:
performing morphological closing on the converted speech signal; and
performing pre-processing on a signal waveform after performing the morphological closing.

3. The method of claim 1, further comprising determining an optimum structuring set size (SSS) of a morphological filter for performing the morphological closing.

4. The method of claim 3, wherein if the SSS is determined the step of performing the morphological operation comprises morphological closing using the determined SSS.

5. The method of claim 3, wherein the predetermined window unit is determined by the SSS and represented using
window unit=(structuring set size (SSS)×2+1).

6. The method of claim 1, wherein the characteristic frequency is a major sine wave component, which is a result of the morphological operation.

7. The method of claim 1, wherein the step of applying the extracted characteristic frequency to the sinusoidal codec comprises applying the characteristic frequency to the sinusoidal codec in harmonic coding.

8. The method of claim 7, wherein the harmonic coding is represented by

|S(ω)·e^{jθ(ω)}=(|P(ω)|·e^{jθ}^{_{P}}^{(ω)}+|N(ω)·e^{jθ}^{_{N}}^{(ω)})·|H(ω)·e^{jθis H}^{(ω)}
where ω denotes the extracted characteristic frequency.

9. The method of claim 2, wherein the pre-processing process is a process of obtaining only harmonic signals remaining by removing staircase signals from a waveform of the converted speech signal.

10. The method of claim 3, wherein the step of determining the optimum SSS comprises:
determining the number of signals having t harmonic peaks greater than a threshold, after performing the pre-processing on the converted speech signal;
calculating an energy ratio according to the number of harmonic peaks;
comparing the energy ratio to a current SSS; and
determining the optimum SSS by adjusting the number of harmonic peaks.

11. The method of claim 10, wherein the optimum SSS is obtained by reducing the number of harmonic peaks if the energy ratio is greater than a predetermined value and increasing the number of harmonic peaks if the energy ratio is less than the predetermined value.

12. The method of claim 1, wherein the speech signal comprises a voiced sound and an unvoiced sound.

13. A morphology-based speech signal codec apparatus comprising:
a frequency domain converter for receiving a speech signal and converting the received speech signal in a time domain to a speech signal in a frequency domain;
a morphological filter for performing a morphological operation on the converted speech signal in a predetermined window unit;
a characteristic frequency region extractor for extracting a characteristic frequency from a result of the morphological operation; and
a sinusoidal codec for applying the extracted characteristic frequency to all speech signals.

14. The apparatus of claim 13, wherein the morphological filter performs pre-processing after morphological closing on the converted speech signal.

15. The apparatus of claim 13, further comprising a structuring set size (SSS) determiner for determining an optimum SSS of the morphological filter for performing the morphological closing on the converted speech signal.

16. The apparatus of claim 15, wherein the morphological filter performs the morphological closing using the SSS determined by the SSS determiner.

17. The apparatus of claim 16, wherein the predetermined window unit is determined by the SSS and represented using
window unit=(structuring set size (SSS)×2+1).

18. The apparatus of claim 13, wherein the characteristic frequency is a major sine wave component, which is a result of the morphological operation.

19. The apparatus of claim 13, wherein the sinusoidal codec performs harmonic coding represented using

|S(ω)·e^{jθ(ω)}=(|P(ω)|·e^{jθ}^{_{P}}^{(ω)}+|N(ω)|·e^{jθ}^{_{N}}^{(ω)})·|H(ω)|·e^{jθ}^{_{H}}^{(ω)}
where ω denotes the extracted characteristic frequency.

20. The apparatus of claim 13, wherein the morphological filter obtains only harmonic signals remaining by removing staircase signals from a waveform of the converted speech signal.

21. The apparatus of claim 13, wherein the speech signal comprises a voiced sound and an unvoiced sound.
